(19) United States
(12) Patent Application Publication
(10) Pub. No.: US 2017/0220161 A1
(43) Pub. Date: Aug. 3, 2017

(54) TOUCH WINDOW

(71) Applicant: LG INNOTEK CO., LTD., Seoul (KR)

(72) Inventors: Young Jae LEE, Seoul (KR); Soo Kwang YOON, Seoul (KR); Hyun Seok LIM, Seoul (KR); Sang Young LEE, Seoul (KR); Tae Jin LEE, Seoul (KR); Joon Rak CHOI, Seoul (KR)

(21) Appl. No.: 15/328,200

(22) PCT Filed: Jul. 28, 2015
(86) PCT No.: PCT/KR2015/007891

§ 371 Date: Jan. 23, 2017

(30) Foreign Application Priority Data
Aug. 4, 2014 (KR) 10-2014-0099665
Sep. 11, 2014 (KR) 10-2014-0120000
Dec. 10, 2014 (KR) 10-2014-0177606

(51) Int. Cl. G06F 3/041; G02F 1/1333; G02F 1/1343; G06F 3/044

(52) U.S. Cl. CPC G06F 3/0412; G06F 3/044; G02F 1/13338; G02F 1/134309; G02F 1/13439; G06F 2203/04112; G02F 2202/28

(57) ABSTRACT

A touch window includes a substrate and an electrode structure on the substrate. The electrode structure includes an electrode layer on the substrate, and a resin layer on the electrode layer. The electrode layer includes a sensing electrode and a wire electrode, and the electrode structure has chromaticness indices (b*) of 0 (zero) or more.

### CROSS-REFERENCE TO RELATED APPLICATIONS

This application is a U.S. National Stage entry from International Application No. PCT/KR2015/007891, filed Jul. 28, 2015, which claims priority to Korean Patent Application Nos. 10-2014-0099665, filed Aug. 4, 2014, 10-2014-0120000, filed Sep. 11, 2014, and 10-2014-0177606, filed Dec. 10, 2014, the disclosure of which is incorporated by reference herein in its entirety.

### BACKGROUND OF THE INVENTION

1. Technical Field

The embodiment relates to a touch window.

2. Description of Related Art

Recently, a touch window, which performs an input function through the touch of an image displayed on a display device by an input device, such as a stylus pen or a finger, has been applied to various electronic appliances.

The touch window may be typically classified into a resistive touch window and a capacitive touch window. In the resistive touch window, glass is short-circuited with an electrode due to the pressure of the input device so that the touch point is detected. In the capacitive touch window, the position of the touch point is detected by detecting the variation of capacitance between electrodes when a finger of the user is touched on the capacitive touch window.

In the resistive type touch panel, the repeated use thereof may degrade the performance thereof, and cause scratches. For this reason, the interest in the capacitive type touch panel representing superior endurance and having a long lifespan is increased.

The touch window may be prepared by disposing an electrode on a substrate. For example, conductive polymer may be used to prepare the electrode.

The conductive polymer has the color sensitivity of blue due to the property of conductive polymer, that is, chromaticness indices having a negative value.

Thus, since the color sensitivity of blue is recognized from an outside, the entire visibility is degraded.

In addition, after the conductive polymer is formed, several processes are required to pattern the conductive polymer.

Therefore, there is a need to provide a touch window having a new structure which may solve the above-mentioned problems.

### SUMMARY OF THE INVENTION

The embodiment is to provide a touch window having improved visibility.

According to one embodiment, there is provided a touch window which includes a substrate; and an electrode structure on the substrate, wherein the electrode structure includes: an electrode layer on the substrate; and a resin layer on the electrode layer, the electrode layer includes a sensing electrode and a wire electrode, and the electrode structure has chromaticness indices (b*) of 0 (zero) or more.

### Advantageous Effects

According to the touch window of the embodiment, the chromaticness indices values of a resin layer serving as an adhesive layer and a sensing electrode serving as an electrode layer may be adjusted so that the entire color sensitivity of the electrode structure may be controlled.

That is, the chromaticness indices value of the electrode structure including the conductive polymer and the resin layer is controlled to have a positive value, so that the typical color sensitivity of blue of the conductive polymer may be prevented from being viewed from an outside.

Therefore, according to the touch window of the embodiment, the visibility may be prevented from being degraded due to the conductive polymer, so that the visibility of the touch window may be improved.

In addition, the electrode member according to an embodiment includes first and second sacrificial substrates and the conductive polymer. The electrode member may be transcribed without regard to a material of a substrate on which the electrode member is transcribed and the conductive polymer may be patterned after removing the first and second sacrificial substrates.

According to the related art, a base substrate has been required to coat the conductive polymer and the conductive polymer patterned on the base substrate has been used as an electrode. That is, the conductive polymer is disposed on the base substrate, and the conductive polymer has been applied in such a manner that the conductive polymer is laminated on or adheres to another substrate.

Thus, it has been difficult to directly dispose the conductive polymer on a glass cover substrate.

However, according to an embodiment, the electrode member is provided by using the sacrifice substrate. After the conductive polymer is disposed on the sacrifice substrate, the electrode member is disposed on the glass cover substrate. Then, the sacrifice substrate is removed so that the conductive polymer makes direct contact with the cover substrate. That is, the conductive polymer may be disposed directly on the cover substrate without any base substrates.

Therefore, the electrode member according to an embodiment may enable the base substrate to be removed when being applied to a touch window, so that the thickness of the touch window may be reduced. In addition, since the electrode member may be transcribed on various types of substrates without regard to a material of the transcribed substrate, when the electrode member is transcribed on an adhesive material, the electrode member may be immediately applied to various devices such as a vehicle or a power supply.

In addition, the touch window according to an embodiment and a touch device including the same may include a sensing electrode or a wire have a fine line width, high transparency and flexibility since the sensing electrode or the wire is formed of conductive polymer. For this reason, the touch window may be enabled to be applied to a curved touch device and a flexible touch device. In addition, according to the touch window, the sensing electrode and the wire may be prevented from being short circuited with each other, so that the reliability may be improved.

Since the conductive polymer includes photosensitive conductive polymer, a process of forming a separated photoresist pattern and stripping the photoresist pattern may be omitted and in addition, an etching process using the photoresist pattern as a mask may be omitted. That is, any etchant and stripping solution may not be used. Thus, the process may be environment friendly and simple and the cost may be reduced.

### BRIEF DESCRIPTION OF DRAWINGS

FIG. 1 is a top view showing a touch window according to an embodiment.

FIG. 2 is a sectional view showing a touch window according to an embodiment.

FIG. 3 is a sectional view showing an electrode member according to an embodiment.

FIG. 4 is a sectional view showing an electrode member according to another embodiment.

FIGS. 5 to 8 are views illustrating a process of applying an electrode member onto a substrate according to an embodiment.

FIGS. 9 to 14 are views illustrating another process of applying an electrode member onto a substrate according to an embodiment.

FIGS. 15 to 17 are views illustrating still another process of applying an electrode member onto a substrate according to an embodiment.

FIGS. 18 to 22 are views illustrating still another process of applying an electrode member onto a substrate according to an embodiment.

FIGS. 23 and 24 are views illustrating a process of forming a sensing electrode according to another embodiment.

FIGS. 25 to 28 are sectional views showing touch windows of which the sensing electrodes are variously disposed according to embodiments.

FIGS. 29 to 31 are views showing a touch device formed by coupling a touch window and a display panel to each other according to an embodiment.

FIGS. 32 to 35 are views showing one example of a touch device to which a touch device according to an embodiment is applied.

### DETAILED DESCRIPTION OF THE INVENTION

In the description of the embodiments, it will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings.

In the following description, when a part is connected to the other part, the parts are not only directly connected to each other, but also indirectly connected to each other while interposing another part therebetween. In addition, when a predetermined part “includes” a predetermined component, the predetermined part does not exclude other components, but may further include other components unless otherwise indicated.

The thickness and size of each layer (film), region, pattern, or structure shown in the drawings may be exaggerated, omitted or schematically drawn for the purpose of convenience or clarity. In addition, the size of each layer (film), region, pattern, or structure does not utterly reflect an actual size.

Hereinafter, embodiments will be described with reference to accompanying drawings.

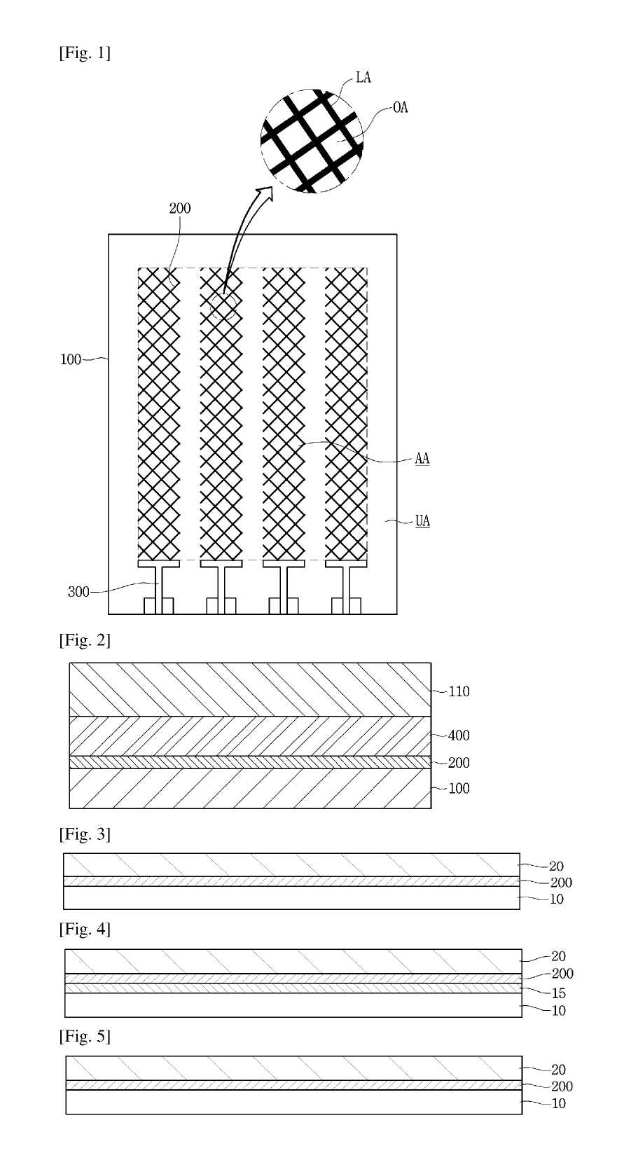

Referring to FIG. 1, the touch window according to an embodiment may include a substrate 100, a sensing electrode and a wire electrode 300.

The substrate 100 may be rigid or flexible.

For example, the protective substrate 100 may include glass or plastic. In detail, the substrate 100 may include chemically tempered/half-tempered glass such as soda lime glass or aluminosilicate glass, reinforced or flexible plastic such as polyimide (PI), polyethylene terephthalate (PET), propylene glycol (PPG), or polycarbonate (PC), or sapphire.

In addition, the substrate 100 may include an optically isotropic film. For example, the substrate 100 may include cyclic olefin copolymer (COC), cyclic olefin polymer (COP), optically isotropic polycarbonate (PC), or optically isotropic polymethyl methacrylate (PMMA).

The sapphire has superior electric characteristics, such as permittivity, so that a touch response speed may be greatly increased and a space touch such as hovering may be easily implemented. In addition, since the sapphire has high surface hardness, the sapphire is applicable to a cover substrate. The hovering refers to a technique of recognizing coordinates even at a slight distance from a display.

In addition, the substrate 100 may be bent to have a partial curved surface. That is, the substrate 100 may be bent to have a partial flat surface and a partial curved surface. In detail, an end of the substrate 100 may be bent to have a curved surface or may be bent or flexed to have a surface including a random curvature.

In addition, the substrate 100 may include a flexible substrate having a flexible property.

In addition, the substrate 100 may include a curved or bended substrate. That is, a touch window including the substrate 100 may be formed to have a flexible, curved or bended property. For this reason, the touch window according to the embodiment may be easily portable and may be variously changed in design.

Sensing and wire electrodes may be disposed on the substrate 100. That is, the substrate 100 may serve as a support substrate.

The substrate 100 may include a cover substrate. That is, the sensing and wire electrodes may be supported by the cover substrate. In addition, an additional cover substrate may be further disposed on the substrate 100. That is, the sensing and wire electrodes may be supported by the substrate 100, and the substrate 100 and the cover substrate may be combined with each other through an adhesive layer. Thus, since the cover substrate and the substrate may be formed separately from each other, it may be advantageous for the mass production of the touch window.

The substrate 100 may have an active area AA and an unactive area UA defined therein.

An image may be displayed on the active area AA. The image is not displayed on the unactive area UA provided at a peripheral portion of the active area AA.

In addition, the position of an input device (e.g., finger) may be sensed in at least one of the active area AA and the unactive area UA. If the input device, such as a finger, touches the touch window, the variation of capacitance occurs in the touched part by the input device, and the touched part subject to the variation of the capacitance may be detected as a touch point.

The sensing electrode 200 may be disposed on the substrate 100. For example, the sensing electrode 200 may be disposed on the active area AA and the unactive area UA. Preferably, the sensing electrode 200 may be disposed on the active area AA of the substrate 100.

The sensing electrode 200 may include a transparent conductive material that allows electricity to flow therethrough without interrupting transmission of light. For example, the sensing electrode 200 may include metal oxide such as indium tin oxide (ITO), indium zinc oxide (IZO), copper oxide, tin oxide, zinc oxide, or titanium oxide. Thus, since the transparent material is disposed on the active area, the degree of pattern freedom in forming the pattern of the sensing electrode may be improved.

Alternatively, the sensing electrode 200 may include a nanowire, a photo sensitive nanowire film, a carbon nanotube (CNT), graphene, conductive polymer or a mixture thereof. Thus, when a flexible or bendable touch window is manufactured, the degree of freedom may be improved.

When a nano-composite such as a nanowire or a carbon nanotube (CNT) is used, the sensing electrode 200 may be formed to have a black color and there is a merit capable of controlling the color and reflectance while securing electric conductivity through the content control of nano-powder.

Alternatively, the sensing electrode 200 may include various metals. For example, the sensing electrode 200 may include at least one of Cr, Ni, Cu, Al, Ag, Mo, Au, Ti and the alloy thereof. Thus, when a flexible or bendable touch window is manufactured, the degree of freedom may be improved.

Preferably, the sensing electrode 200 may include conductive polymer. For example, the sensing electrode 200 may include at least one of thermosetting conductive polymer and photo-curable conductive polymer.

The sensing electrode 200 formed of the conductive polymer may have flexibility and may be applied to a flexible touch device or curved touch device. In addition, when the substrate 100 is bent, the sensing electrode 200 may be bent without any physical damage. That is, the sensing electrode 200 may be prevented from being short-circuited, so that the reliability may be improved.

Therefore, the sensing electrode 200 may be applied to a large size of a touch window, and the large size of a touch window may be applied to a flexible or curved touch device. In addition, the bending properties and reliability of a touch window and a touch device may be improved.

In addition, the conductive polymer has a low density. Thus, a touch window and a touch device having light weights may be formed.

For example, an electrode layer 300 may include at least one conductive polymer from among polyaniline, polyphenylenevinylene, polythienylenevinylene, polyacetylene, polypyrrole, polythiophene, poly(3-alkylthiophene), polyphenylenevinylene, polythienylenevinylene, polyphenylene, polyisothianaphthene, polyazulene and polyfuran.

The sensing electrode 200 may be formed in a mesh shape. In detail, the sensing electrode 200 may include a plurality of sub-electrodes. The sub-electrodes may be disposed in a mesh shape while crossing each other.

In detail, the sensing electrode may include mesh lines LA formed by the plurality of sub-electrodes crossing each other in the mesh shape, and mesh opening parts OA formed between the mesh lines LA.

In this case, a line width of the mesh line LA may be in the range of about 0.1 μm to about 10 μm. It may be impossible in terms of the fabrication process to form the mesh line LA having a line width less than about 0.1 μm. When the line width of the mesh line LA exceeds about 10 μm, the sensing electrode pattern may be viewed from an outside so that the visibility may be degraded. Preferably, the mesh line LA may have a line width in the range of about 0.5 μm to about 7 μm. More preferably, the mesh line LA may have a line width in the range of about 1 μm to about 3.5 μm.

In addition, the mesh opening part OA may be formed in various shapes. For example, the mesh opening part OA may have various shapes such as a polygonal shape including a rectangular shape, a diamond shape, a pentagon shape or a hexagonal shape, or a circular shape. In addition, the mesh opening part OA may have a regular or random shape.

As the sensing electrode 200 has a mesh shape, for example, the pattern of the sensing electrode may be made not to be viewed in the active area AA. In other words, even when the sensing electrode is formed of metal, the pattern may be made not to be viewed. In addition, even when the sensing electrode is applied to a large-size touch window, the resistance of the touch window may be reduced. In addition, the sensing and wire electrodes may be simultaneously patterned with the same material, so that the process efficiency may be improved.

The wire electrode 300 may be disposed on the substrate 100. For example, the wire electrode 300 may be disposed on at least one of the active area AA and the unactive area UA of the substrate 100.

In addition, the wire electrode 300 may be connected to the sensing electrode 200. For example, one end of the wire electrode 300 may be connected to the sensing electrode 200 and the opposite end may be connected to a printed circuit board (not shown) disposed on the unactive area UA.

Thus, the sensed touch signal from the sensing electrode may be transferred through the wire electrode to the printed circuit board on which a driving chip is mounted and then, may be transferred to a main board chip through the driving chip, so that a touch operation may be performed.

Although not shown in the drawings, an outer dummy layer may be further disposed on the unactive area UA of the substrate 100. In addition, the wire electrode 300 may be disposed on the outer dummy layer.

The outer dummy layer may allow the wire electrode disposed on the unactive area and the printed circuit board connecting the wire electrode to an external circuit not to be viewed from an outside.

The outer dummy layer may be formed by coating a material having a predetermined color such as ink. Alternatively, the outer dummy layer may be formed by attaching a film having a predetermined color.

The outer dummy layer may have a color suitable for a desired outer appearance thereof. For example, the outer dummy layer may be black or white in color. Alternatively, when the film is attached, various colors such as red or blue may be shown by using various color films.

In addition, a desired logo may be formed in the outer dummy layer through various schemes. The outer dummy layer may be formed through deposition, print, and wet coating schemes.

The outer dummy layer may include at least one layer. For example, the outer dummy layer may consist of one layer or at least two layers having mutually different widths.

The wire electrode 300 may include a conductive material. For example, the wire electrode 300 may include a material the same as or similar to that of the sensing electrode 200.

In addition, the wire electrode 300 may include a plurality of mesh lines which cross each other to be formed in a mesh shape. Since the mesh lines of the wire electrode 300 is identical or similar to the mesh lines of the sensing electrode, the details will be omitted.

Referring to FIG. 2, an electrode structure may be disposed on the substrate 100. For example, the electrode structure which includes an electrode layer including the sensing electrode 200 and a resin layer 400 may be disposed on the substrate 100.

In addition, the cover substrate 110 may be disposed on the substrate. That is, the electrode structure may be interposed between the substrate 100 and the cover substrate 110.

The resin layer 400 may attach the substrate 100 to the cover substrate 110. The resin layer 400 may include an adhesive material. For example, the resin layer 400 may be an adhesive layer.

The electrode structure may have chromaticness indices (b*) of a positive value. In detail, the chromaticness indices of the electrode structure may have 0 (zero) or more. That is, the chromaticness indices (b*) of the electrode structure including the sensing electrode 200 and the resin layer 400 may have 0 (zero) or more.

When, the chromaticness indices (b*), which is one of color coordinate units, has a negative value, the chromaticness indices (b*) may correspond to blue. When the chromaticness indices (b*) has a positive value, the chromaticness indices (b*) may have yellow. In addition, blue or yellow may be deepened according to a value of the chromaticness indices (b*).

The value of the chromaticness indices (b*) may be measured through a color coordinate measuring device. For example, after a target object, of which the chromaticness indices (b*) is to be measured, is disposed on a polyethylene terephthalate (PET) substrate, the chromaticness indices (b*) of the target object may be measured based on the light reflected upon the surface by using the color coordinate measuring device.

For example, when the value of the chromaticness indices (b*) is increased into the positive value, the color may represent yellow. When the value of the chromaticness indices (b*) is decreased into the negative value, the color may represent blue.

The sensing electrode 200 and the resin layer 400 may have inherent chromaticness indices (b*), respectively. In detail, the sensing electrode 200 and the resin layer 400 may have mutually different chromaticness indices (b*). For example, the sensing electrode 200 may have chromaticness indices (b*) of a negative value (−). In addition, the resin layer 400 may have chromaticness indices (b*) of a positive value (+).

That is, the sensing electrode 200 may have a blue color, and the resin layer 400 may have a yellow color. For example, the sensing electrode 200 may include conductive polymer. That is, the sensing electrode 200 may include blue conductive polymer having chromaticness indices (b*) of a negative value.

The chromaticness indices (b*) of the electrode structure including the sensing electrode 200 and the resin layer 400 may have a positive value. That is, the chromaticness indices (b*) of the electrode structure, in which the sensing electrode 200 having chromaticness indices (b*) of a positive value and the resin layer 400 having chromaticness indices (b*) of a negative value are stacked, may totally have a positive value.

Thus, since the chromaticness indices (b*) of the electrode structure is a positive value, the electrode structure, in which the sensing electrode 200 having chromaticness indices (b*) of a positive value and the resin layer 400 having chromaticness indices (b*) of a negative value are stacked, may be entirely yellow. Therefore, the blue color, which is the color sensitivity of the sensing electrode 200, that is, the inherent color sensitivity of the conductive polymer, may be prevented from being viewed from an outside.

That is, when the resin layer having chromaticness indices (b*) of a negative value is disposed on the sensing electrode having chromaticness indices (b*) of a positive value, the chromaticness indices (b*) of a positive value may be offset against the chromaticness indices (b*) of a negative value, so that a blue color is prevented from being viewed from an outside.

The chromaticness indices (b*) of the resin layer 400 may have the value of about 3 or greater. The chromaticness indices (b*) of the resin layer 400 may have a value in the range of about 3 to about 12. When the chromaticness indices (b*) of the resin layer 400 may have a value less than about 3, the chromaticness indices (b*) of the electrode structure may have a negative value, so that the electrode structure may entirely have a blue color. When the chromaticness indices (b*) of the electrode structure exceeds the value of about 12, the chromaticness indices (b*) of the electrode structure may have too great a value so that the electrode structure may entirely have a deep yellow color.

In addition, the chromaticness indices (b*) of the electrode structure, in which the sensing electrode 200 and the resin layer 400 are stacked, may have a positive value less than 2.5. When the chromaticness indices (b*) of the electrode structure has a value greater than 2.5, the yellow color corresponding to the value of the chromaticness indices (b*) may be viewed from an outside.

Hereinafter, the embodiments will be described in more detail through comparative examples. The embodiments and the comparative examples are only proposed for the purpose of description. Thus, the embodiment is not limited thereto.

### Embodiment 1

The sensing electrode including the conductive polymer was disposed on the substrate. The touch window was fabricated by disposing the cover substrate on the resin layer.

The chromaticness indices (b*) of the sensing electrode has a negative value and the chromaticness indices of the resin layer had the value of about 3.

Then, the chromaticness indices of the stack structure in which the sensing electrode and the resin layer are stacked was measured.

### Embodiment 2

A touch window the same as that of Embodiment 1 was manufactured except that the resin layer has the chromaticness indices (b*) value of about 7, and the chromaticness indices of the stack structure of the sensing electrode and resin layer was measured.

### Embodiment 3

A touch window the same as that of Embodiment 1 was manufactured except that the resin layer has the chromaticness indices (b*) value of about 12, and the chromaticness indices of the stack structure of the sensing electrode and resin layer was measured.

### COMPARATIVE EXAMPLE 1

A touch window the same as that of Embodiment 1 was manufactured except that the resin layer has the chromaticness indices (b*) value of about 0.2, and the chromaticness indices (b*) of the stack structure of the sensing electrode and resin layer was measured.

### COMPARATIVE EXAMPLE 2

A touch window the same as that of Embodiment 1 was manufactured except that the resin layer has the chromaticness indices (b*) value of about 2, and the chromaticness indices (b*) of the stack structure of the sensing electrode and resin layer was measured.

### COMPARATIVE EXAMPLE 3

A touch window the same as that of Embodiment 1 was manufactured except that the resin layer has the chromaticness indices (b*) value of about 15, and the chromaticness indices (b*) of the stack structure of the sensing electrode and resin layer was measured.

| | Chromaticness indices value |
|---|---|
| Embodiment 1 | +0.52 |
| Embodiment 2 | +1.01 |
| Embodiment 3 | +2.32 |
| Comoarative example 1 | −1.40 |
| Comoarative example 2 | −0.75 |
| Comoarative example 3 | +3.0 |

Referring to Table 1, it may be known that the chromaticness indices (b*) of the stack structures of Embodiments 1 to 3 have positive values. That is, the value of the entire chromaticness indices of the stack structure may be changed into a positive value by disposing the resin layer having chromaticness indices (b*) in the range of 3 to 12 on the sensing electrode having a negative value.

To the contrary, in the cases of comparative examples 1 and 2, it may be known that the chromaticness indices (b*) of the stack structure has a negative value. That is, it may be known that the stack structure has a blue color which is the inherent color of the sensing electrode, that is, the conductive polymer.

In addition, in the case of comparative example 3, it may be known that the chromaticness indices (b*) of the stack structure has a positive value or the value of 3 or more. That is, it may be known that the touch window has a clear yellow color which is a color of the stack structure.

According to the touch window of an embodiment, the entire color sensitivity may be controlled by adjusting the chromaticness indices values of the resin layer serving as an adhesive layer and the sensing electrode serving as an electrode layer.

That is, the chromaticness indices value of the electrode structure including the conductive polymer and the resin layer is controlled to have a positive value, so that the typical color sensitivity of blue of the conductive polymer may be prevented from being viewed from an outside.

Therefore, according to the touch window of the embodiment, the visibility may be prevented from being degraded due to the conductive polymer, so that the visibility of the touch window may be improved.

Hereinafter, a process of disposing the sensing electrode including conductive polymer according to an embodiment on a substrate will be described with reference to FIGS. 3 to 22.

FIG. 3 shows an electrode member. The electrode member may include first and second sacrificial substrates 10 and 20 and a sensing electrode 200.

The first sacrificial substrate 10 may support the second sacrificial substrate 20 and the sensing electrode 200.

The first sacrificial substrate 10 may include plastic. In detail, the first sacrificial substrate 100 may include plastic such as polyethylene terephthalate (PET). In more detail, the first sacrificial substrate 100 may include a silicon layer formed on at least one of both surfaces of a substrate. For example, the first sacrificial substrate 10 may include a release film. Thus, the first sacrificial substrate 10 may be attached easily and detachably.

Alternatively, the first sacrificial substrate 10 may include photosensitive material. In addition, the first sacrificial substrate 10 may be non-conductive. For example, the first sacrificial substrate 10 may be a photosensitive film. Thus, the first sacrificial substrate 10 may allow a patterning process to be easily performed.

The first sacrificial substrate 10 may be transparent or translucent. That is, the first sacrificial substrate 10 may be transparent to transmit light therethrough or translucent. Preferably, the first sacrificial substrate 10 may be transparent.

The sensing electrode 200 may be disposed on the first sacrificial substrate 10. The sensing electrode 200 may include conductive polymer described above. In detail, the sensing electrode 200 may include at least one of thermosetting conductive polymer and photo-curable conductive polymer.

The sensing electrode 200 may be directly or indirectly disposed on the first sacrificial substrate 10. For example, the electrode layer 30 may be disposed while making direct contact with the first sacrificial substrate 10.

Alternatively, the sensing electrode 200 may be disposed without making direct contact with the first sacrificial substrate 10. For example, referring to FIG. 4, a preprocessing layer 15 may be further disposed on the first sacrificial layer 15, and the sensing electrode 200 may be disposed on the preprocessing layer 15. That is, the sensing electrode 200 may be disposed while making direct contact with the preprocessing layer 15. The preprocessing layer 15 may improve the coupling strength, that is, the adhesion strength between the first sacrificial substrate 10 and the sensing electrode 200.

The second sacrificial substrate 20 may be disposed on the sensing electrode 200. The second sacrificial substrate 20 may be disposed while making direct contact with the sensing electrode 200. In addition, the second sacrificial substrate 20 may be disposed on a partial surface or the entire surface of the sensing electrode 200. For example, the second sacrificial substrate 20 may be disposed on the entire surface of the sensing electrode 200.

The second sacrificial substrate 20 may be disposed on the sensing electrode 200 so that the sensing electrode 200 may be protected from external impurities. For example, the second sacrificial substrate 20 may include a protective film for protecting the electrode layer 30.

The second sacrificial substrate 20 may include plastic. For example, the second sacrificial substrate 20 may include silicon-based or acrylic-based plastic

Hereinafter, a process of applying the electrode member according to an embodiment onto another substrate will be described with reference to FIGS. 5 to 8.

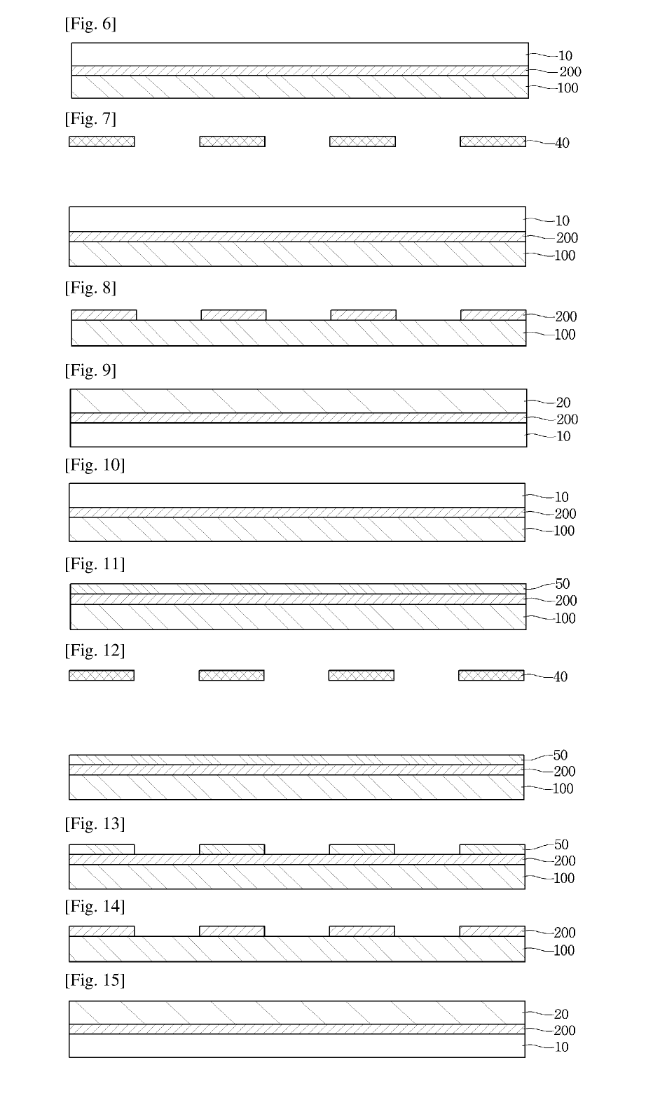

Referring to FIGS. 5 and 6, the electrode member may be transcribed on the substrate 100. For example, the second sacrificial substrate 20 of the electrode member may be removed. That is, after the second sacrificial substrate 20 on the sensing electrode 200 is removed, the electrode member may be transcribed on the substrate 100 to allow the sensing electrode 200 and the substrate 100 to make contact with each other. In this case, the sensing electrode 200 may include photo-curable conductive polymer.

Referring to FIG. 7, an exposure process may be performed after a mask 40 is disposed on the substrate 100. Thus, the electrode layer including the photo-curable conductive polymer may be patterned.

Then, referring to FIG. 8, a development process may be performed after the first sacrificial substrate 10 is removed. Finally, the electrode layer including the photo-curable conductive polymer may be patterned.

Hereinafter, another process of applying the electrode member according to an embodiment onto another substrate will be described with reference to FIGS. 9 to 14.

Referring to FIGS. 9 and 10, the electrode member may be transcribed on the substrate 100. For example, the second sacrificial substrate 20 of the electrode member may be removed. That is, after removing the second sacrificial substrate 20 on the sensing electrode 200, the electrode member may be transcribed on the substrate 100, such that the sensing electrode and the substrate 100 make contact with each other. In this case, the electrode layer may include thermosetting conductive polymer.

Next, referring to FIG. 11, the first sacrificial substrate 10 may be removed. That is, the first sacrificial substrate 10 on the sensing electrode 200 may be removed. Then, after curing the exposed sensing electrode 200, that is, the conductive polymer by heat or light, a photosensitive material may be disposed on the sensing electrode 200. For example, a photosensitive material 50 such as photoresist (PR) may be disposed on the sensing electrode 200.

Next, referring to FIGS. 12 to 14, the sensing electrode 200 may be patterned. For example, after disposing a mask on the substrate 100, the sensing electrode may be patterned through exposure, development and etching processes.

In detail, referring to FIG. 12, the substrate 100 on which the mask is disposed is exposed to light such as UV light through the exposure process. Then, referring to FIG. 13, after the substrate 100 is immersed in a development solution, the photosensitive material of a non-masked portion is removed. Next, referring to FIG. 14, after immersing the substrate 100 in an etching solution to etch the photosensitive material non-coated portion, the residual photosensitive material is removed, so that the sensing electrode 200 may be finally patterned.

Hereinafter, still another process of applying the electrode member according to an embodiment onto another substrate will be described with reference to FIGS. 15 to 17.

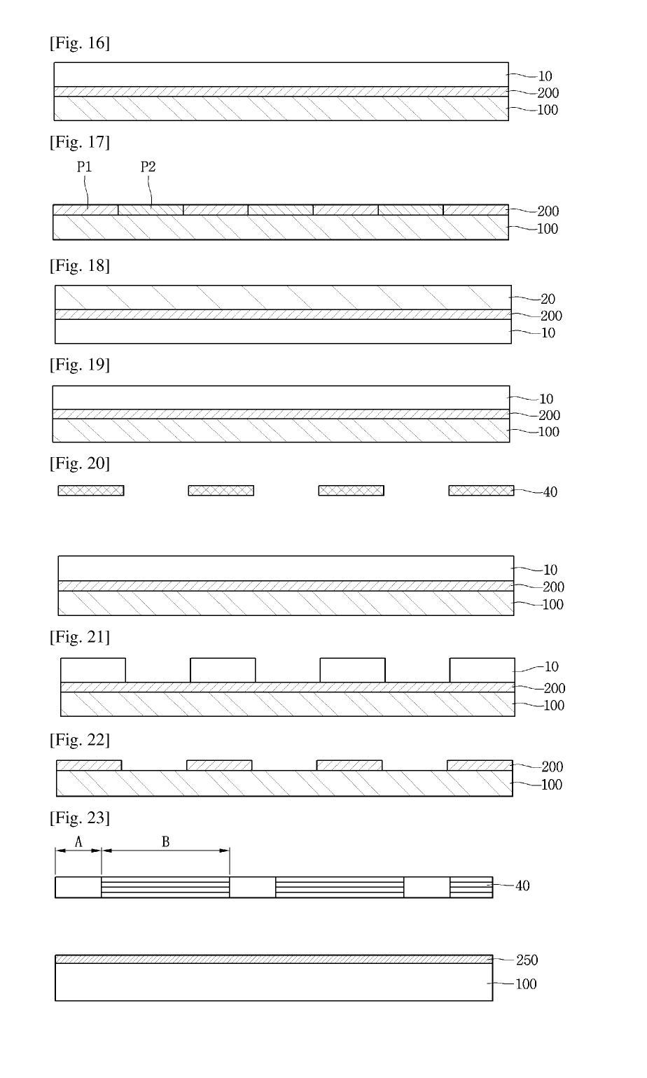

Referring to FIGS. 15 and 16, the electrode member may be transcribed on the substrate 100. For example, the second sacrificial substrate 20 of the electrode member may be removed. That is, after removing the second sacrificial substrate 20 on the sensing electrode 200, the electrode member may be transcribed on the substrate 100, such that the sensing electrode and the substrate 100 make contact with each other. In this case, the electrode layer may include photo-curable conductive polymer or thermosetting conductive polymer.

Then, referring to FIG. 17, the first sacrificial substrate 10 may be removed. That is, after the first sacrificial substrate 10 on the sensing electrode 200 may be removed, the sensing electrode 200 may be patterned. For example, after a mask is disposed on the substrate 100, the substrate 100 may be patterned by using a dedoping solution. For example, the sensing electrode 200 may be partially dedoped by using a hydroxide-based dedoping solution such as a sodium hydroxide (NaOH). Thus, the electrode layer may be patterned to have a fine pattern of 10 μm or less. For example, the electrode layer may be formed in a mesh form.

Thus, the sensing electrode 200 may be formed thereon with a first pattern part P1 and a first non-pattern part NP1. That is, the sensing electrode 200 may be finally patterned in such a manner that the first electrode layer 410 may be formed thereon with the first pattern part P1 having conductivity and not dedoped with the dedoping solution and the first non-pattern part NP1 having no conductivity and dedoped with the dedoping solution.

Hereinafter, still another process of applying the electrode member according to an embodiment onto another substrate will be described with reference to FIGS. 18 to 22.

Referring to FIGS. 18 and 19, the electrode member may be transcribed on the substrate 100. For example, the second sacrificial substrate 20 of the electrode member may be removed. That is, after the second sacrificial substrate 20 on the sensing electrode 200 is removed, the electrode member may be transcribed on the substrate 100 to allow the sensing electrode 200 and the substrate 100 to make contact with each other.

Next, the sensing electrode 200 may be patterned. For example, after disposing a mask on the substrate 100, the sensing electrode may be patterned through exposure, development and etching processes.

In this case, the first sacrificial substrate 10 disposed on the sensing electrode 200 may include a photosensitive material. Thus, the process of disposing the photosensitive material on the sensing electrode 200 may be omitted, so that the exposure, development and etching processes may be immediately performed.

In detail, referring to FIG. 20, the substrate 100 on which the mask is disposed is exposed to light such as UV light through the exposure process. Then, referring to FIG. 21, after the substrate 100 is immersed in a development solution, the first sacrificial substrate 10 of a non-masked portion is removed. Next, referring to FIG. 22, after immersing the substrate 100 in an etching solution to etch the region on which the first sacrificial substrate 10 is not disposed, the residual region of the first sacrificial substrate 10 is removed, so that the sensing electrode 200 may be finally patterned.

The electrode member according to an embodiment includes the first and second sacrificial substrates and the conductive polymer. The electrode member may be transcribed without regard to a material of the substrate on which the electrode member is transcribed, and the conductive polymer may be patterned after removing the first and second sacrificial substrates.

According to the related art, a base substrate has been required to coat the conductive polymer and the conductive polymer patterned on the base substrate has been used as an electrode. That is, the conductive polymer is disposed on the base substrate, and the conductive polymer has been applied in such a manner that the conductive polymer is laminated on or adheres to another substrate.

Thus, it has been difficult to directly dispose the conductive polymer on a glass cover substrate.

However, according to an embodiment, the electrode member is provided by using the sacrifice substrate. After the conductive polymer is disposed on the sacrifice substrate, the electrode member is disposed on the glass cover substrate. Then, the sacrifice substrate is removed so that the conductive polymer makes direct contact with the cover substrate. That is, the conductive polymer may be disposed directly on the cover substrate without any base substrates.

Therefore, the electrode member according to an embodiment may enable the base substrate to be removed when being applied to a touch window, so that the thickness of the touch window may be reduced. In addition, since the electrode member may be transcribed on various types of substrates without regard to a material of the transcribed substrate, when the electrode member is transcribed on an adhesive material, the electrode member may be immediately applied to various devices such as a vehicle or a power supply.

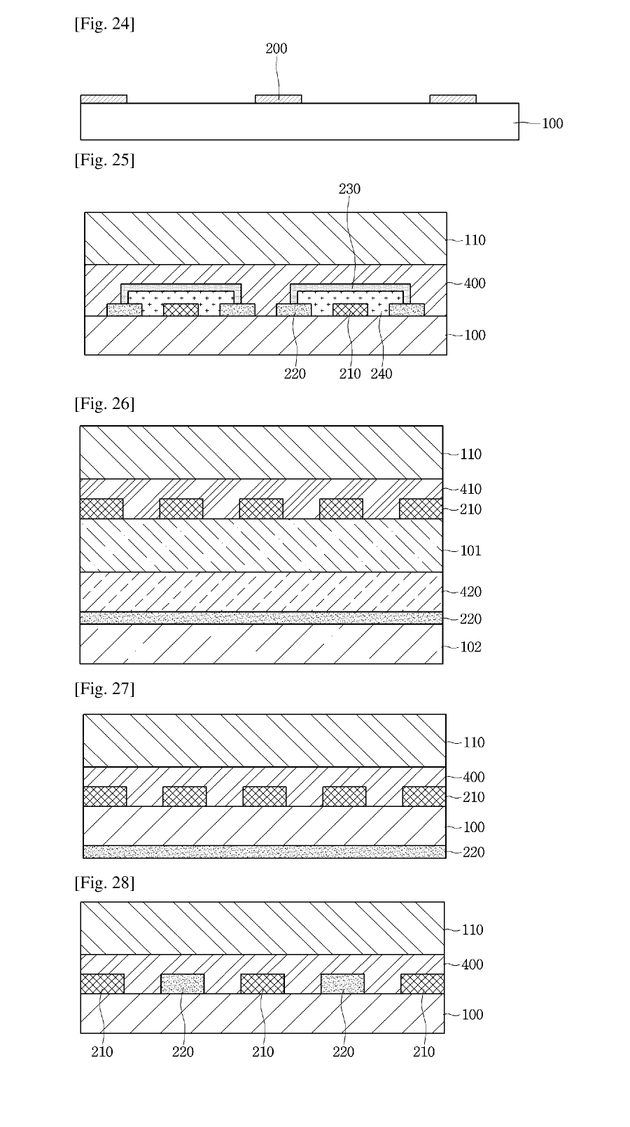

Hereinafter, a manufacturing process according to another embodiment will be described with reference to FIGS. 23 and 24.

Referring to FIGS. 23 and 24, a photosensitive conductive polymer material 250 may be coated on an entire surface of the substrate 100. Then, after a mask 40 is disposed on the photosensitive conductive material 250, light may be irradiated thereon.

In this case, the photosensitive conductive polymer may be negative or positive photosensitive conductive polymer. The negative photosensitive conductive polymer may be a material cured when light is irradiated thereon. In addition, the positive photosensitive conductive polymer may be a material softened when light is irradiated thereon. That is, the photosensitive conductive polymer may be a material either cured or softened when light is irradiated thereon. The light may include ultraviolet rays (UV).

The mask 40 may include transmissive and non-transmissive parts. When the photosensitive conductive polymer material 250 is negatively photosensitive, the photosensitive conductive polymer material 250 of the region corresponding to the transmissive part A of the mask 40 is cured. Then, when a development process is performed, the non-cured photosensitive conductive polymer material 250 may be removed. That is, the sensing electrode 200 may be formed in the region corresponding to the transmissive part A of the mask 40.

When the photosensitive conductive polymer material 250 is positively photosensitive, the photosensitive conductive polymer material 250 of the region corresponding to the transmissive part B of the mask 40 is softened. Then, when a development process is performed, the softened photosensitive conductive polymer material 250 may be removed. That is, the sensing electrode 200 may be formed in the region corresponding to the non-transmissive part A of the mask 40.

When the conductive polymer is formed by using the conductive polymer through an inkjet or screen printing scheme, it is difficult to form a fine line width. Thus, by forming the sensing electrode through a mask process, the sensing electrode may be formed to have a fine line width.

In addition, when the sensing electrode is formed by using the thermosetting conductive polymer, an additional photoresist pattern must be formed after coating the conductive polymer on the entire surface of the substrate. That is, the photosensitive photoresist material is coated on the conductive polymer material and the mask is disposed on the photoresist material. Then, after irradiating light, the photoresist pattern is formed through a development process. According to an etching process, the conductive polymer material is oxidized with an etchant by using the photoresist pattern as a mask, so that non-conductivity is imparted to the region except for the sensing electrode. In this case, the etchant may include strong acid. Thereafter, the photoresist pattern is stripped to be removed, thereby completing the sensing electrode.

That is, the processes of forming the photoresist pattern, oxidizing the conductive polymer material and removing the photoresist pattern are required. Therefore, when the thermosetting conductive polymer is used, the process is complex and the cost is increased. In addition, since the strong acid and stripping solution are used, it is not eco-friendly.

Therefore, according to the process of the embodiment, the sensing electrode is formed by using the photosensitive conductive polymer to form the additional photoresist pattern, so that the process of stripping the photoresist pattern may be omitted. In addition, the etching process for imparting non-conductivity by using the photoresist pattern as a mask may be omitted too. That is, the etchant and the stripping solution may not be used. For this reason, the process may be simple and eco-friendly and the cost may be reduced.

The photosensitive conductive polymer may be removed from the region except for the sensing electrode through the development process. That is, there is formed no polymer in the region except for the sensing electrode 200. In addition, the photosensitive conductive polymer may be disposed only on the region in which the sensing electrode is formed.

Although the processing of patterning the conductive polymer on the sensing electrode has be described above, the embodiment is not limited thereto and the process according to the embodiment may be equally applied to a case of patterning the wire electrode including the conductive polymer.

Hereinafter, touch windows variously embodied according to the position of a sensing electrode will be described with reference to FIGS. 25 to 28.

Referring to FIG. 25, the touch window according to the embodiment may include a cover substrate 110 and a substrate 100, and the first and second sensing electrodes 210 and 220 may be disposed on the same surface of the substrate 100.

For example, the first and second sensing electrode 210 and 220 may be disposed on the same surface of the substrate 100 and an insulating layer 260 may be disposed on the first and second sensing electrodes 210 and 220.

A bridge electrode 230 may be disposed on the insulating layer 260. The bridge electrode 230 may be disposed while connecting the second sensing electrodes 220 to each other. Thus, the first and second sensing electrode 210 and 220 may extend on the same surface of the substrate 100 in mutually different directions without being short-circuited with each other.

Thus, since the first and second sensing electrodes all are disposed on one substrate, the entire thickness of the touch window may be reduced. In addition, an attaching process to another substrate may be omitted, so that the processing efficiency may be improved.

A resin layer 400 may be interposed between the cover substrate 110 and the substrate 100, so that the cover substrate 110 and the substrate 100 may be attached to each other through the resin layer 400.

In addition, at least one of the first and second sensing electrodes 210 and 220 may include conductive polymer, and as described above, the chromaticness indices of the electrode structure including the first and second electrodes 210 and 220 and the resin layer 400 may be controlled to have a positive value.

Referring to FIG. 26, the touch window according to the embodiment may include a cover substrate 110 and first and second substrates 101 and 102. The first sensing electrode 210 may be disposed on the first substrate 101 and the second sensing electrode 220 may be disposed on the second substrate 102.

In addition, a first resin layer 410 may be interposed between the cover substrate 110 and the first substrate 101, and the cover substrate 110 and the first substrate 101 may be attached to each other through the first resin layer 410.

In addition, a second resin layer 420 may be interposed between the first and second substrates 101 and 102, and the first and second substrates 101 and 102 may be attached to each other through the second resin layer 410.

Thus, since the first and second sensing electrodes are disposed on each substrate, the process of forming an insulating layer may be omitted.

In addition, at least one of the first and second sensing electrodes 210 and 220 may include conductive polymer, and as described above, the chromaticness indices of the electrode structure including the first sensing electrode 210 and the first resin layer 410 and the electrode structure including the second sensing electrode 210 and the second resin layer 420 may be controlled to have positive values.

Referring to FIG. 27, the touch window according to the embodiment may include a cover substrate 110 and a substrate 100, and the first and second sensing electrodes 210 and 220 may be disposed on both surfaces of the substrate 100 opposite to each other, respectively.

A resin layer 400 may be interposed between the cover substrate 110 and the substrate 100, so that the cover substrate 110 and the substrate 100 may be attached to each other through the resin layer 400.

Thus, since the first and second sensing electrodes are disposed on both surfaces of one substrate, respectively, an attaching process to another substrate may be omitted, so that the processing efficiency may be improved.

In addition, at least one of the first and second sensing electrodes 210 and 220 may include conductive polymer, and as described above, the chromaticness indices of the electrode structure including the first and second electrodes 210 and 220 and the resin layer 400 may be controlled to have a positive value.

Referring to FIG. 28, the touch window according to the embodiment may include a cover substrate 110 and a substrate 100, and the first and second sensing electrodes 210 and 220 may be disposed on the same surface of the substrate 100.

For example, the first and second sensing electrode 210 and 220 may be disposed on the same surface of the substrate 100 while being spaced apart from each other.

That is, differently from the touch window of FIG. 3, the first and second sensing electrode 210 and 220 may be spaced apart from each other without requiring the insulating layer and the bridge electrode.

Thus, since the first and second sensing electrodes all are disposed on one substrate, the entire thickness of the touch window may be reduced. In addition, an attaching process to another substrate may be omitted, so that the processing efficiency may be improved.

A resin layer 400 may be interposed between the cover substrate 110 and the substrate 100, so that the cover substrate 110 and the substrate 100 may be attached to each other through the resin layer 400.

In addition, at least one of the first and second sensing electrodes 210 and 220 may include conductive polymer, and as described above, the chromaticness indices of the electrode structure including the first and second electrodes 210 and 220 and the resin layer 400 may be controlled to have a positive value.

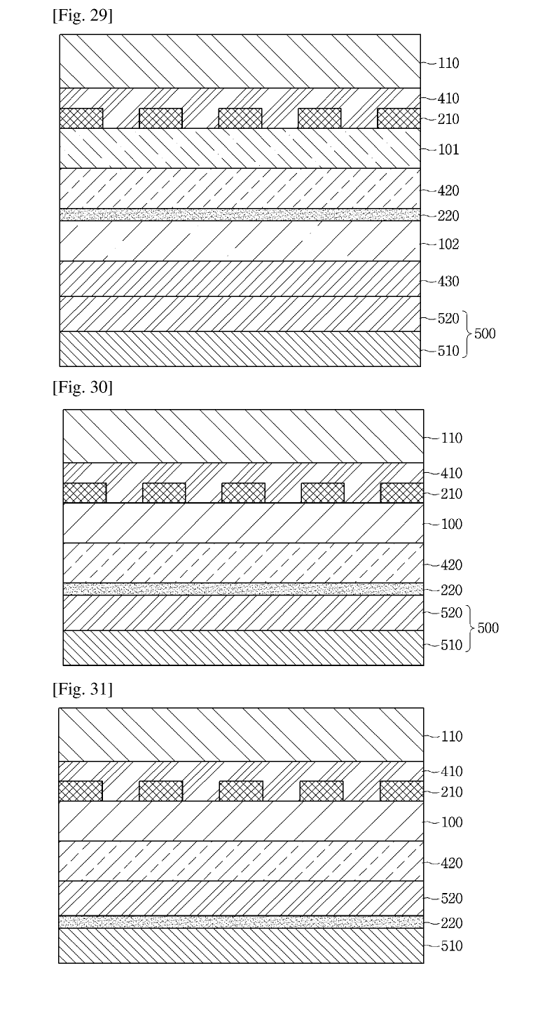

Hereinafter, a touch device, in which the above-described touch window and a display panel are coupled to each other, will be described with reference to FIGS. 29 to 31.

Referring to FIG. 29, the touch device according to an embodiment may include the touch window disposed on the display panel 500.

In detail, referring to 29, the touch window includes a cover substrate 110, and first and second substrates 101 and 102. A first sensing electrode 210 may be disposed on the first substrate 101 and a second sensing electrode 220 may be disposed on the second substrate 102. In addition, the cover substrate 110, and the first and second substrates 101 and 102 may be attached to each other through first and second resin layers 410 and 420.

In addition, the display panel 500 and the touch window may be attached to each other through a third resin layer 430.

In addition, at least one of the first and second sensing electrodes 210 and 220 may include conductive polymer, and as described above, the chromaticness indices of the electrode structure including the first sensing electrode 210 and the first resin layer 410 and the electrode structure including the second sensing electrode 210 and the second resin layer 420 may be controlled to have positive values.

The display panel 500 may include third and fourth substrates 510 and 520.

If the display panel 500 is a liquid crystal display panel, the display panel 500 may have a structure in which the third substrate 510 including a thin film transistor (TFT) and a pixel electrode is combined with the fourth substrate 620 including color filter layers while a liquid crystal layer is interposed between the third and fourth substrates 610 and 620.

Further, the display panel 500 may be a liquid crystal display panel having a color filter on transistor (COT) structure formed by combining the third substrate 510 formed thereon with the TFT, a color filter, and a black matrix with the fourth substrate 520 while the liquid crystal layer is interposed between the third and fourth substrates 510 and 520. In other words, the TFT may be formed on the third substrate 510, a protective layer may be formed on the TFT, and the color filter layer may be formed on the protective layer. In addition, the pixel electrode, which makes contact with the TFT, is formed on the third substrate 510. In this case, to improve an aperture ratio and simplify a mask process, the black matrix may be omitted, and a common electrode may perform a function of the black matrix together with the inherent function thereof.

In addition, when the display panel 500 is a liquid crystal panel, the display device may further include a backlight unit for providing light at the back of the display panel 500.

When the display panel 600 is an organic light emitting device, the display panel 500 includes a self-light emitting device which does not require any additional light source. A thin film transistor is formed on the third substrate 510 of the display panel 500, and an organic light-emitting device (OLED) making contact with the thin film transistor is formed. The OLED may include an anode, a cathode and an organic light-emitting layer formed between the anode and the cathode. In addition, the display panel 500 may further include the fourth substrate 520, which performs the function of an encapsulation substrate for encapsulation, on the OLED.

Referring to FIG. 30, a touch device according to an embodiment may include a touch window formed integrally with the display panel 500. That is, a substrate supporting at least one sensing electrode may be omitted.

In detail, at least one sensing electrode may be disposed on at least one surface of the display panel 500. That is, at least one sensing electrode may be formed on at least one surface of the third and fourth substrate 510 or 520.

In this case, at least one sensing electrode may be formed on a top surface of the substrate disposed at an upper portion.

Referring to FIG. 30, the touch window may include a cover substrate 110 and a substrate 100. The first sensing electrode 210 may be disposed on the substrate 100 and the cover substrate 110 and the substrate 100 may be attached to each other through a first resin layer 410.

In addition, the second sensing electrode 500 may disposed on one surface of the display panel 500. Further, the touch window and the display panel 500 may be attached to each other through a second resin layer 420.

In addition, at least one of the first and second sensing electrodes 210 and 220 may include conductive polymer, and as described above, the chromaticness indices of the electrode structure including the first sensing electrode 210 and the first resin layer 410 and the electrode structure including the second sensing electrode 210 and the second resin layer 420 may be controlled to have positive values.

In addition, the cover substrate 100 may further include a polarizing plate below the cover substrate 100. The polarizing plate may be a linear polarizing plate or an anti-reflection polarizing plate. For example, when the display panel 600 is a liquid crystal display panel, the polarizing plate may be a linear polarizing plate. In addition, when the display panel 600 is an organic electroluminescent display panel, the polarizing plate may be an anti-reflection polarizing plate.

In addition, the second sensing electrode 220 may be disposed on the polarizing plate.

At least one substrate 100 for supporting the sensing electrode 300 may be omitted from the touch device of FIG. 30. Thus, the touch device having a thin thickness and a light weight may be formed.

Referring to FIG. 31, a touch device according to an embodiment may include a touch panel integrated with the display panel 600. That is, the substrate for supporting at least one sensing electrode may be omitted.

For example, a sensing electrode, which serves as a sensor disposed in an active area to sense a touch, and a wire, through which an electrical signal is applied to the sensing electrode, may be formed inside the display panel. In detail, at least one sensing electrode or at least one wire may be disposed inside the display panel.

The display panel includes the third and fourth substrates 510 and 520. In this case, at least one of the first and second sensing electrodes 210 and 220 is disposed between the third and fourth substrates 510 and 520. That is, at least one sensing electrode may be disposed on at least one surface of the third and fourth substrate 510 or 520.

Referring to FIG. 31, the touch window may include a cover substrate 110 and a substrate 100. The first sensing electrode 210 may be disposed on the substrate 100 and the cover substrate 110 and the substrate 100 may be attached to each other through a first resin layer 410.

In addition, the sensing electrode 220 may be interposed between the third and fourth substrates 510 and 520. That is, the second sensing electrode 220 may be disposed inside the display panel and the first sensing electrode 210 may be disposed outside of the display panel.

The second sensing electrode 220 may be disposed on the top surface of the third substrate 510 or the rear surface of the fourth substrate 520.

In addition, a polarizing plate may be further provided at a lower portion of the cover substrate 100.

When the display panel is a liquid crystal display panel and the second sensing electrode is formed on the top surface of the third substrate 510, the sensing electrode may be formed with a thin film transistor (TFT) or a pixel electrode. In addition, when the second sensing electrode is formed on the rear surface of the fourth substrate 520, a color filter layer may be formed on the sensing electrode or the sensing electrode may be formed on the color filter layer. When the display panel is an organic light emitting device and the second sensing electrode is formed on the top surface of the third substrate 510, the second sensing electrode may be formed with a thin film transistor or an organic light emitting device.

The touch device of FIG. 1 may allow at least one substrate supporting a sensing electrode 300 to be omitted. For this reason, the touch device having a thin thickness and a light weight may be formed. In addition, the sensing electrode and the wire are formed with a device formed on the display panel, so that the process may be simplified and the cost may be reduced.

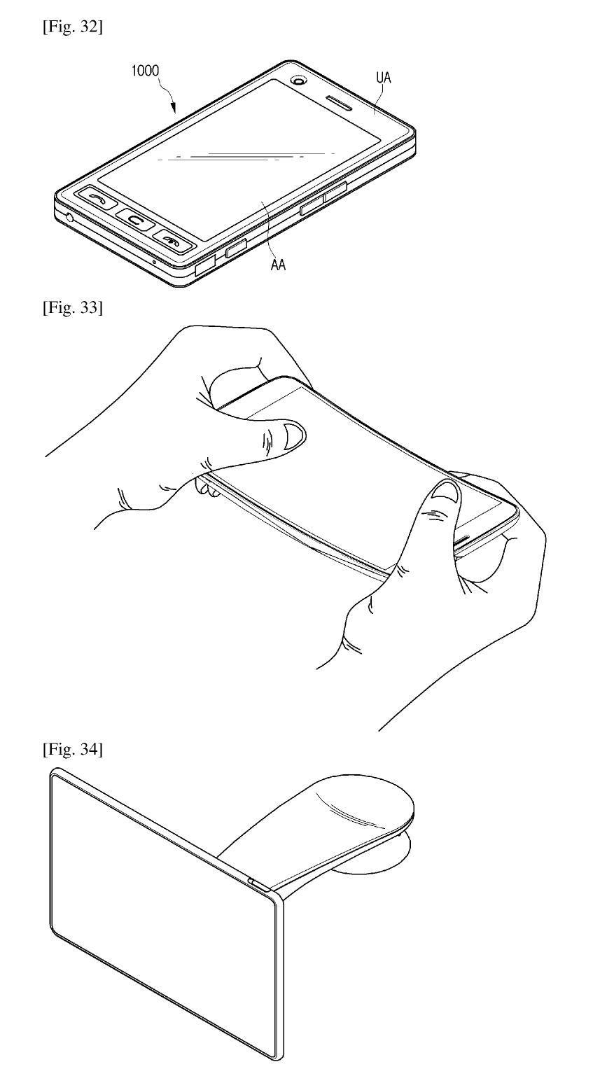

Hereinafter, one example of a display device, to which a touch window according to the embodiment described above is applied, will be described with reference to FIGS. 32 to 35.

Referring to FIG. 32, as one example of a touch device, a mobile terminal is shown. The mobile terminal may include an active area AA and an unactive area UA. The active area AA may sense a touch signal through the touch by a finger, and a command icon pattern part and a logo may be formed in the unactive area UA.

Referring to FIG. 33, the touch window may include a flexible touch window that is capable of being bent. Accordingly, the touch display including the flexible touch window may be a flexible touch display. Thus, a user may bend or curve the flexible touch window with the hand of the user. Such a flexible touch window may be applied to a wearable touch.

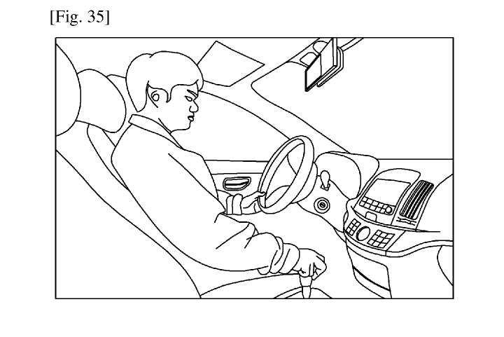

Referring to FIG. 34, the touch window may be applied to a vehicle navigation system as well as a touch device such as a mobile terminal.

In addition, referring to FIG. 23, the touch window may be applied to an inner part of a vehicle. In other words, the touch window may be applied to various parts in the vehicle. Accordingly, the touch window may be applied to a dashboard 100 as well as a PND (Personal Navigation Display), so that a CID (Center Information Display) may be realized. However, the embodiment is not limited to the above, and such a touch device may be used for various electronic appliances.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A touch window comprising:
a substrate; and
an electrode structure on the substrate,
wherein the electrode structure includes:
an electrode layer on the substrate; and
a resin layer on the electrode layer,
wherein the electrode layer includes a sensing electrode and a wire electrode, and
wherein the electrode structure has chromaticness indices (b*) of 0 (zero) or more.

2. The touch window of claim 1, wherein the electrode layer has chromaticness indices (b*) of a negative (−) value, and the resin layer has chromaticness indices (b*) of a positive (+) value.

3. The touch window of claim 1, wherein at least one of the sensing electrode and the wire electrode includes conductive polymer.

4. The touch window of claim 1, wherein at least one of the sensing electrode and the wire electrode has a mesh shape.

5. The touch window of claim 1, wherein the electrode structure has chromaticness indices of a positive value less than 2.5.

6. An electrode member comprising:
a first sacrificial substrate;
an electrode layer on the first sacrificial substrate; and
a second sacrificial substrate on a sensing electrode,
wherein the sensing electrode includes conductive polymer, and
the first and second sacrificial substrates include mutually different materials.

7. The touch window of claim 6, wherein:
the first sacrificial substrate includes a release film, and
the second sacrificial substrate includes a protective film.

8. The touch window of claim 6, wherein the first sacrificial substrate includes a photosensitive material.

9. The touch window of claim 6, further comprising a preprocessing layer on the first sacrificial substrate,
wherein the electrode layer is disposed on the preprocessing layer.

10. The touch window of claim 6, wherein the sensing electrode has a mesh shape.

11. The touch window of claim 1, wherein the chromaticness indices (b*) of the resin layer has a value in the range of 3 to 12.

12. The touch window of claim 1, wherein the electrode structure is yellow color.

13. The touch window of claim 1, further comprising a cover substrate on the substrate.

14. The touch window of claim 3,
wherein the sensing electrode includes a first sensing electrode and a second sensing electrode, and
wherein the first sensing electrode and the second sensing electrode are extended on the same surface of the substrate in mutually different directions.

15. The touch window of claim 13,
wherein the sensing electrode includes a first sensing electrode and a second sensing electrode,
wherein the first sensing electrode is disposed on the cover substrate, and
wherein the second sensing electrode is disposed on the substrate.

16. The touch window of claim 3,
wherein the sensing electrode includes a first sensing electrode and a second sensing electrode,
wherein the first sensing electrode is disposed on one surface of the substrate, and
wherein the second sensing electrode is disposed on other surface of the substrate.

17. The touch window of claim 3,
wherein the substrate includes a first substrate and a second substrate on the first substrate,
wherein the sensing electrode includes a first sensing electrode and a second sensing electrode,
wherein the first sensing electrode is disposed on the first substrate, and
wherein the second sensing electrode is disposed on the second substrate.

18. A touch device:
a display panel; and
a touch window on the display panel,
wherein the touch window comprises:
a substrate; and
an electrode structure on the substrate, wherein the electrode structure includes:
an electrode layer on the substrate; and
a resin layer on the electrode layer,
wherein the electrode layer includes a sensing electrode and a wire electrode, and
wherein the electrode structure has chromaticness indices (b*) of 0 (zero) or more.

19. The touch device of claim 18, wherein the electrode layer has chromaticness indices (b*) of a negative (−) value, and the resin layer has chromaticness indices (b*) of a positive (+) value.

20. The touch device of claim 18, wherein the electrode structure has chromaticness indices of a positive value less than 2.5.
